(19) United States
(12) Patent Application Publication
(10) Pub. No.: US 2026/0098764 A1
(43) Pub. Date: Apr. 9, 2026

(54) Critical Temperature Indicator (CTI)

(71) Applicant: Michael Tyler Sells, Mexico, MO (US)

(72) Inventor: Michael Tyler Sells, Mexico, MO (US)

(21) Appl. No.: 19/318,060

(22) Filed: Sep. 3, 2025

Related U.S. Application Data
(60) Provisional application No. 63/703,291, filed on Oct. 4, 2024.

(51) Int. Cl. G01K 11/06; G01K 1/02

(52) U.S. Cl. CPC G01K 11/06; G01K 1/02

(57) ABSTRACT

A temperature indication apparatus includes a compact, two-piece, length-adjustable housing sized for installation in an OEM dipstick port. A temperature-actuated mechanism within the housing employs a phase-change material that restrains a compressed spring below a predetermined activation temperature and releases the spring upon transition at or above the activation temperature. Release of the spring drives a flag from a stowed position to a deployed position visible external to the housing, providing a visual indication of overheating to facilitate shutdown and maintenance.

### FIELD OF THE INVENTION

The present invention generally relates to temperature sensing and indication devices. More particularly, the present invention relates to a temperature sensor apparatus with a visual indicator configured to alert a user of an overheating condition in industrial or agricultural equipment.

### BACKGROUND OF THE INVENTION

Small work equipment—such as two-stroke and compact gasoline engines, brush cutters, grain augers, transfer gearcases, final drives, and hydraulic power units—is built for simplicity and low maintenance and typically relies on oil for lubrication and cooling. When oil is lost or degrades, or when contamination, misalignment, bearing damage, or poor ventilation occurs, internal temperature rises, wear accelerates, and sudden failure can result. Operators often have poor access to check ports and, absent visible leakage, may skip routine checks, so overheating can go unnoticed.

Existing temperature monitoring solutions are either electronic or non-electronic. Electronic systems (wired or wireless heat/vibration sensors tied to maintenance software) can work well but need power, communications, and support, making them costly and impractical for single components, dispersed assets, or small and medium-sized enterprises. Non-electronic indicators (color-change labels, diffusion-based or fluid-filled devices) are often hard to see in service, do not hold up in oil-wetted environments, have limited selectable trip temperatures, and can be fragile or expensive to make.

Standard dipsticks and breathers are common, but they do not provide a positive, temperature-triggered indication of internal overheating. Plant status lights signal machine state but do not provide passive, per-component over-temperature detection on remote or mobile equipment.

There is a need for a simple, robust, low-cost temperature sensor apparatus that installs in place of an existing dipstick or breather, requires no external power or networking, can be adjusted to the original-equipment oil-level position, and gives a clear external visual signal when an internal temperature threshold is exceeded. Such a device would enable earlier intervention, reduce unplanned downtime, and extend component life in industrial, agricultural, and mobile applications. The present invention addresses this need.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A temperature sensor apparatus provides a passive, fail-safe visual indication when an internal lubricant or environment exceeds a selected temperature threshold. In a preferred embodiment, the apparatus includes a two-piece, length-adjustable housing configured to install in an OEM dipstick port, a temperature-actuated mechanism enclosed within the housing, and an outwardly deployable indication flag. A temperature-sensitive material, such as a meltable wax formulated for a specific activation temperature, restrains a compressed spring during normal operation.

When the monitored temperature reaches the threshold, the material transitions state and releases the spring, which drives the flag through an aperture in the cap to a persistent, visible position. The visible indication alerts an operator to shut down equipment and initiate preventative maintenance before catastrophic failure.

The housing includes an upper housing with installation threads, wrench flats, and a cap aperture for flag deployment, and a lower housing engaged by adjustable length threads to set insertion depth relative to the equipment fluid level. Set screws lock the selected length. Visual oil-level markings may be provided on the lower housing. In certain embodiments, a breather journal is integrated to accommodate thermal expansion and pressure equalization. In some implementations, a base magnet located at the immersed end of the lower housing collects ferrous particulates from the lubricant to provide an additional indication of abnormal wear.

In another embodiment, the temperature sensor mechanism is formed as a removable subassembly that includes the indication flag, a retainer assembly, the actuation spring, and the temperature-sensitive material contained within a thin-walled shell. The subassembly is insertable into the lower housing for rapid service and allows selection among different activation temperatures by substitution, thereby enabling customization and maintenance without removing the entire housing from the equipment.

The apparatus is dimensioned and constructed to withstand the thermal and mechanical environment within gearboxes, engines, and other fluid-lubricated machinery, and provides a clear, persistent, external over-temperature indication without requiring external power or communications.

### BRIEF DESCRIPTION OF THE DRAWINGS

FIG. 1 is a cross-sectional view of an embodiment of the temperature sensor apparatus, in accordance with aspects of the present invention.

FIG. 2 is a top view of an embodiment of the temperature sensor apparatus.

FIG. 3 is a side view of an embodiment of the temperature sensor apparatus.

FIG. 4 is a cross-sectional view of the temperature sensor apparatus in use.

FIG. 5 is a cross-sectional view of an alternative embodiment of the present invention.

### DETAIL DESCRIPTIONS OF THE INVENTION

All illustrations of the drawings are for the purpose of describing selected versions of the present invention and are not intended to limit the scope of the present invention.

As a preliminary matter, a person of ordinary skill in the art will recognize that this disclosure has broad utility and application. Any embodiment may include one or more of the disclosed aspects and one or more of the disclosed features. Embodiments identified as “preferred” reflect the best mode contemplated for carrying out the invention. Additional embodiments may be described to provide a complete and enabling disclosure. Numerous variations—such as adaptations, modifications, alternative configurations, and equivalent arrangements—are also encompassed within the scope of this disclosure.

Accordingly, although specific embodiments are described in detail, the disclosure is illustrative and exemplary only, provided to enable those skilled in the art to make and use the invention. The detailed description is not intended to limit the scope of patent protection, which is defined solely by the claims and their equivalents. No limitation should be read into any claim that does not explicitly appear in the claim language.

For example, any sequences or temporal orders of steps described for processes or methods are illustrative, not restrictive. Unless stated otherwise, steps may be performed in different sequences or orders while remaining within the scope of the disclosure. The scope of protection is determined by the issued claims, not by the order of steps shown in the description.

Each term used herein has the meaning that a person of ordinary skill in the art would attribute to it in the context provided. If such contextual meaning differs from a dictionary definition, the skilled artisan's understanding controls. As used herein, “a” and “an” generally mean “at least one,” unless the context dictates otherwise. In lists, “or” means “at least one of” the listed items and does not exclude a plurality, and “and” means all listed items.

The detailed description refers to the accompanying drawings, using the same reference numerals where possible for the same or similar elements. Although many embodiments may be described, modifications, adaptations, substitutions, additions, and rearrangements of elements or method stages can be made without departing from the scope of the disclosure. Headings are provided for convenience and are not limiting of the subject matter that follows.

This disclosure includes many aspects and features. While numerous aspects are described in the context of methods, systems, apparatuses, and devices for a visual indicator configured to alert a user of an overheating condition, the embodiments are not limited to that context.

### Overview

The present invention, a temperature sensor apparatus 100, provides a mechanical, fail-safe visual indication when a monitored lubricant or environment exceeds a predetermined temperature threshold. In preferred embodiment, the apparatus 100 includes an adjustable, two-piece housing configured for installation in an Original Equipment Manufacturer (OEM) dipstick port, a temperature-actuated mechanism contained within the housing, and an outwardly deployable indication flag.

A temperature-sensitive material restrains a compressed spring under normal operating temperatures. Upon reaching a threshold temperature, the material transitions state, releasing the spring to drive the indication flag into a visible position, thereby alerting an operator to shut down the equipment and perform preventative maintenance.

In certain embodiments, a magnetic abrasion indicator mounted at the housing base collects ferrous particulates to provide an additional condition signal. In other embodiments, the temperature sensor mechanism is provided as a removable subassembly to enable rapid service and temperature-range customization.

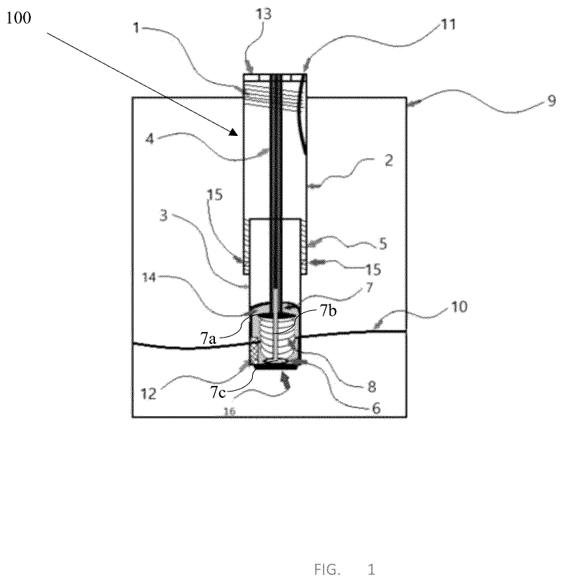

FIGS. 1-5 illustrate embodiments of the temperature sensor apparatus 100 with the following components:
1 Device installation threads
2 Upper housing
3 Lower housing
4 Indication flag
5 Adjustable length threads
6 Indicator/retainer
7 Wax melting material
8 Wax-encased compressed spring
9 Gearbox (illustrative external housing)
10 Gearbox internal fluid level
11 Breather journal
12 Hash marks (visual oil level)
13 Wrench flats (Cap)
14 Specific-temperature melting wax
15 Set screws (length retention Q-2)
16 Base magnet (loose metal collection)

Referring to FIGS. 1-3, a temperature sensor apparatus 100 is shown installed within an external housing 9, such as a gearbox or engine. The external housing 9 contains moving components and a cooling/lubricating fluid (e.g., oil), with a portion of the apparatus 100 disposed within the fluid at level 10. The apparatus 100 is dimensioned for installation in an OEM dipstick port and is configured to withstand the thermal and mechanical environment of the equipment.

### Housing

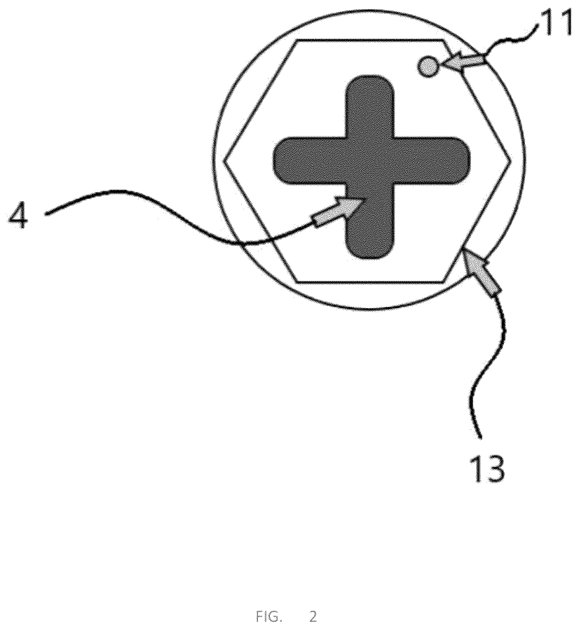

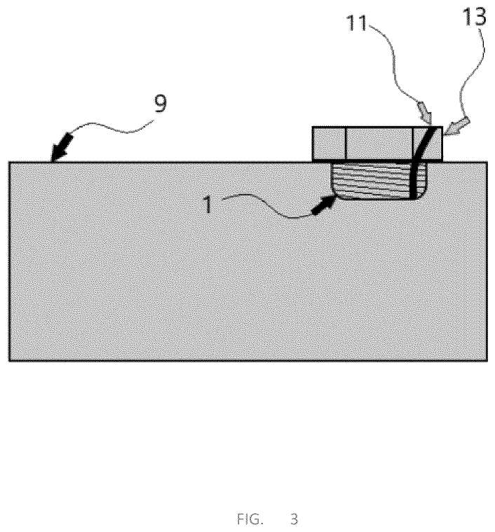

In a preferred embodiment, the apparatus 100 includes a two-piece housing comprising an upper housing 2 and a lower housing 3. The upper housing 2 is generally tubular or substantially cylindrical and includes device installation threads 1 proximate a first end to receive a breather journal 11. The cap 13 may be wrench flats 13 for tool engagement and at least one aperture (which can be in various shape including a plus shape as shown in FIG. 2) through which an indication flag 4 is configured to extend and remain visible. In certain embodiments, the cap 13 further includes an auxiliary aperture to receive a breather element (e.g., a breather journal 11 as shown in FIG. 3) that accommodates thermal expansion and pressure equalization.

The upper housing 2 includes adjustable length threads 5 at a second end for extendable and retractable engagement with the lower housing 3. By rotating the upper housing 2 relative to the lower housing 3, the overall insertion depth of the apparatus 100 into the external housing 9 can be set. Once a desired length is achieved, one or more set screws 15 disposed through the upper housing 2 are actuated to bear against the lower housing 3, thereby fixing the relative axial position of the housings 2, 3. The lower housing 3 may include visual fluid-level markings 12 or an indicator 6 proximate its immersed end to provide an operator with an oil-level reference when installed.

### Temperature Sensor Mechanism

The housings 2, 3 cooperate to enclose a temperature sensor mechanism. In one embodiment, the mechanism includes an indication flag 4 arranged to transition from a stowed position to a deployed, visible position when an overheating condition is detected. The flag 4 can be tubular and fixed at a first end to a disk-shaped head 7a carried by the upper housing 2, with a second end disposed beneath or within the cap 13.

A retainer assembly 6 supports and constrains the flag 4. In one embodiment, a retainer rod 7b extends between the disk-shaped head 7a and a lower disk-shaped head 7c to form the retainer 6. The actuation mechanism is disposed between the disk-shaped heads 7a, 7c and includes a spring 8 maintained in a compressed state by a temperature-sensitive material, such as a wax 7, 14 selected to transition at a predetermined temperature. The temperature-sensitive material is arranged so that, below the threshold, it mechanically restrains the spring 8; above the threshold, it changes state (e.g., solid-to-liquid), releasing the spring 8 to drive the flag 4 outward through the cap 13 to a persistent, visible position.

### Abrasion Indicator

In some embodiments, an abrasion indicator is provided at the base of the lower housing 3, positioned to be submerged in the fluid during operation. The abrasion indicator may include a base magnet 16 configured to collect ferrous particulates suspended in the lubricant, thereby providing an additional diagnostic cue of abnormal wear in the equipment (e.g., gearbox 9, engine, or other lubrication-dependent machinery). Accumulation of metallic debris on the magnet 16 indicates potential component wear or impending failure.

### Operation

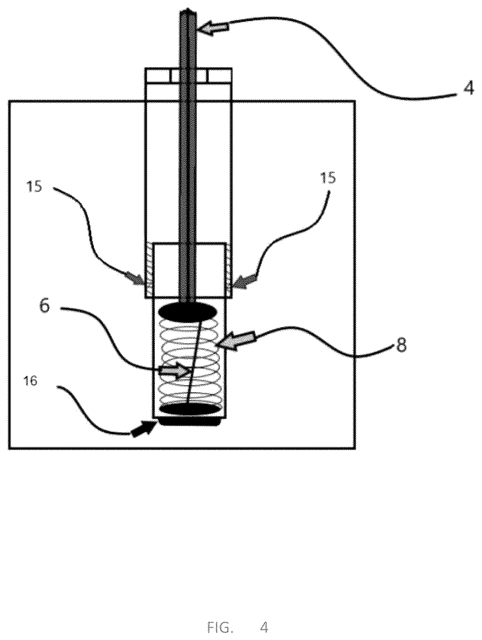

Referring to FIG. 4, the temperature sensor mechanism is thermally coupled to the lubricant within the external housing 9. During normal operation, the temperature-sensitive material 7, 14 retains the spring 8 in compression, keeping the flag 4 within or beneath the cap 13. When the lubricant temperature reaches the predetermined threshold, the material 7, 14 transitions state, permitting the spring 8 to decompress. The decompression forces the flag 4 to translate outward through the cap 13. The geometry of the retainer rod 7b and the mating disk-shaped head 7a is configured so that, upon deployment, the rod 7b becomes unseated from the head 7a, inhibiting retraction and thereby providing a persistent visual overheating indication. The visible indication prompts the operator to halt operation and perform maintenance before catastrophic failure.

### Removable Subassembly

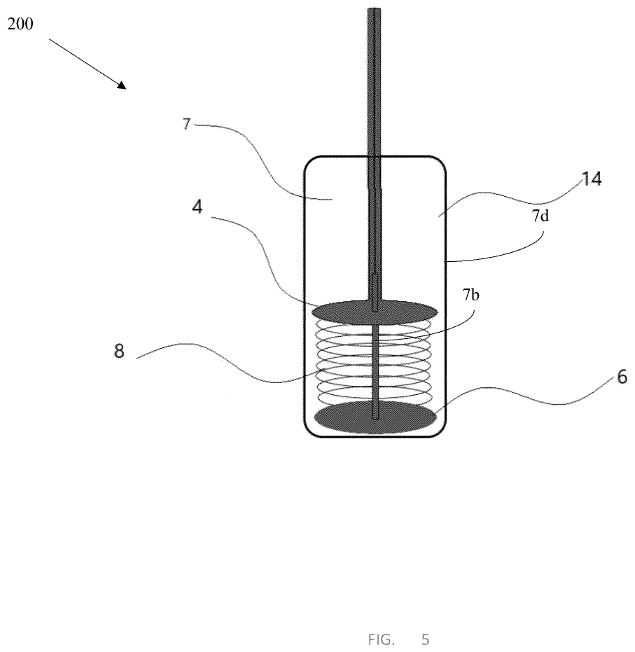

FIG. 5 illustrates an embodiment in which the temperature sensor mechanism-comprising the flag 4, retainer 6 including rod 7b and heads 7a, 7c, the actuation spring 8, and the temperature-sensitive material 14 is integrated into a removable subassembly 200 having a container 7d.

The subassembly 200 can be sized to be insertable into the lower housing 3 while the upper and lower housings 2, 3 remain installed. This configuration facilitates rapid replacement of the sensing mechanism and selection of alternate actuation temperatures by substituting encapsulated components within the subassembly 200. In certain implementations, the subassembly 200 is enclosed in a thin-walled shell (e.g., a polymer tube) that provides sufficient structural integrity while enabling efficient heat transfer to the temperature-sensitive material 14, thereby minimizing thermal lag and enabling accurate threshold response.

What is claimed is:

1. An apparatus comprising:
an upper housing having upper threads;
a lower housing having lower threads configured to mate with the upper threads;
a cap coupled to the upper housing and defining an aperture;
a retainer including a retainer rod and a second head;
a flag mechanically coupled to the retainer and configured to be viewable through the aperture;
a first head coupled to the flag and axially opposed to the second head;
a spring disposed between the first head and the second head and configured to exert a biasing force tending to separate the first head and the second head; and
a temperature-sensitive material disposed between the first head and the second head and configured to restrain the spring below a threshold temperature and to release the spring upon the temperature-sensitive material changing state at or above the threshold temperature.

2. The apparatus of claim 1, wherein the cap includes wrench flats configured to receive a hand tool.

3. The apparatus of claim 1, wherein the aperture is sized to permit the flag to translate from a stowed position within the cap to a deployed position protruding outward of the cap.

4. The apparatus of claim 1, wherein the upper housing and the lower housing are relatively adjustable in length by threaded engagement of the upper threads and the lower threads.

5. The apparatus of claim 4, further comprising one or more set screws disposed in the upper housing and configured to bear against the lower housing to lock the relative length.

6. The apparatus of claim 1, wherein the temperature-sensitive material comprises a wax formulated to melt at a predetermined temperature between 80° C. and 140° C.

7. The apparatus of claim 1, further comprising a magnet located at a distal end of the lower housing and configured to collect ferrous particulates from a lubricant.

8. The apparatus of claim 1, wherein the spring is maintained in compression by the temperature-sensitive material when below the threshold temperature.

9. The apparatus of claim 1, wherein deployment of the flag causes the retainer rod to unseat from the first head to inhibit retraction of the flag after deployment.

10. The apparatus of claim 1, wherein the lower housing includes visual level indicia configured to indicate a fluid level when the device is installed in an equipment sump.

11. The apparatus of claim 1, wherein the cap further comprises a breather passage configured to relieve pressure during thermal expansion.

12. An apparatus comprising:
an upper housing having upper threads and a first axial end;
a lower housing having lower threads and a second axial end, the lower threads configured to mate with the upper threads to adjust an insertion depth of the device;
a cap attached to the first axial end of the upper housing and including an opening;
a retainer including a retainer rod extending along an axis of the apparatus and terminating at a lower, second head;
a flag attached to the retainer and movable between a non-visible position and a visible position at the opening, wherein the flag includes a cylindrical tube for through which the retainer rod is inserted;
a first head attached to the flag and facing the second head;
a spring disposed between the first head and the second head; and
a temperature-responsive restraining element comprising a phase-change material positioned adjacent the spring and configured to mechanically restrain the spring in a first state and to permit expansion of the spring in a second state reached at a predetermined temperature, thereby driving the flag toward the visible position.

13. The apparatus of claim 12, wherein the phase-change material is encapsulated in a thin-wall capsule that promotes heat transfer from a surrounding lubricant.

14. The apparatus of claim 12, wherein the flag comprises a high-contrast color or reflective surface to enhance visibility when in the visible position.

15. The apparatus of claim 12, wherein the cap includes a seal selected from an O-ring or gasket to inhibit ingress of contaminants into the upper housing.

16. The apparatus of claim 12, wherein the spring is a helical compression spring having a spring constant selected to fully deploy the flag within less than one second after the predetermined temperature is reached.

17. The apparatus of claim 12, wherein the upper housing and the lower housing are dimensioned to replace an original-equipment dipstick assembly of a gearbox or engine.

18. An apparatus comprising:
a retainer having a second head and a retainer rod coupled to the second head;
a flag coupled to the retainer;
a first head coupled to the flag and axially opposed to the second head;
a spring disposed between the first head and the second head; and
a temperature-sensitive material disposed with the spring between the first head and the second head, the temperature-sensitive material being configured to maintain the spring in a restrained condition below a threshold temperature and to allow the spring to extend at or above the threshold temperature so as to drive the flag from a stowed position to a deployed position.

19. The container of claim 18, wherein the apparatus is a removable subassembly sized for insertion into a housing of a host device.

20. The apparatus of claim 19, wherein the temperature-sensitive material, the spring, the first head, the second head, the retainer rod, and the flag are enclosed within a thin-walled shell configured for replacement with shells having different threshold temperatures.
